(19) United States
(12) Patent Application Publication
(10) Pub. No.: US 2011/0113235 A1
(43) Pub. Date: May 12, 2011

(54) PC Security Lock Device Using Permanent ID and Hidden Keys

(76) Inventor: Craig Erickson, Stevenson Ranch, CA (US)

(21) Appl. No.: 12/870,776

(22) Filed: Aug. 27, 2010

Related U.S. Application Data
(60) Provisional application No. 61/275,428, filed on Aug. 27, 2009.

(51) Int. Cl. H04L 29/06; G06F 21/00; H04L 9/00

(52) U.S. Cl. 713/152; 713/192; 713/172

(57) ABSTRACT

The invention is a method, system, and apparatus providing user control and security of a PC system. Using the hardware and associated installation software, the system is capable of uniquely securing a PC system without the need for name and password entry. The secure USB device contains a unique asymmetrical key pair, unique device ID, secure storage area, and the firmware to control all of this. In providing the security and control, one embodiment of the invention does not require biomechanical devices or name and password entry systems. There are no passwords and login names to be found, and the encryption/decryption keys are protected from exposure. This provides a more secure environment, as the keys are protected from exposure. The user is in control of the PC system and the data which is desired to be kept secure.

### RELATED APPLICATIONS

The present application claims priority under 35 U.S.C. §119(e) to U.S. Provisional Patent Application No. 61/275,428, filed Aug. 27, 2009, entitled “PC Security Lock Device Using Permanent ID and Hidden Keys,” the contents of which are expressly incorporated herein by reference in their entirety.

### FIELD OF THE INVENTION

The present invention relates to the secure protection/encryption and boot sequence control of computer systems (including personal computer aka PC systems), email, email attachments, and data via secure encryption and hidden permanent asymmetrical key pairs, and more particularly, the creation and manipulation of secure data and secure drives linked only to a specific unique secure dongle having permanent asymmetrical key pairs and identification code(s) (ID), wherein the private keys and ID are not exposed.

### BACKGROUND

PC systems, especially portable laptops, are vulnerable to loss, theft, and data copying. In many PC security systems, a user is required to enter or create a name and password, and this name and password combination allows the user to access the data or the system. Many operating systems have this security system built into them. Other various security checks can also be used, including biomechanical solutions which allow for fingerprint scanning, facial scanning, etc. of features unique to a user. Such other security checks can be added on top of the traditional name and password security measures.

It can be undesirable to require the user to enter/locate this information (i.e., name and password) each time the user wishes to access the encrypted content. The repeated entry of such information can be time consuming, particularly where access is repeatedly sought. Additionally, the name and password are often lost or forgotten, requiring a secondary validation system by the provider that allows the user to retrieve the missing information on the very account that the user had created. In many cases, the name and password data can be irretrievably lost. This same problem occurs with the biomechanical devices in that when they do not operate properly, the user must resort to the name and password entry that they had tried to eliminate in the first place.

Therefore, it is desirable to provide a device and recovery system that is capable of automatically identifying each individual user and not requiring the repetitive input of user data or requiring the placement of cookies on the individual system(s). Such a desirable hardened security device and supporting system should not require the use and input of passwords that are easily obtained and that allow the system to be circumvented. The system should allow recovery of the securely encrypted data even if the original device is lost or stolen, while allowing the user to still have access to their computer and data without requiring workaround passwords to that system and data.

### SUMMARY

The invention is a system and method using a hardened secure USB device and accompanying support system software that registers, runs, encrypts/decrypts, organizes, and protects the unique data for an individual user's computer system, such as a local PC system. The invention can include the creation of so-called virtual vault file drives on the hard drive (or other memory components) of the local PC system, with the virtual vault file drives only being visible and/or accessible to a user when the secure USB device is secured to or otherwise in communication with the local PC system. The invention can include the encryption and decryption of emails and other materials to be transmitted via the internet or similar communication systems.

The secure USB device may be in the form of a dongle. A dongle is a piece of hardware sometimes used to limit access to a computer. A dongle can contain a memory having access codes or other data (keys, etc.) and a processor configured to make various calculations. In typical dongle operation, the dongle is connected to a port (e.g., serial, parallel, USB) of a local computer. Software running on the local computer sends information (e.g., a number) to the dongle, and the dongle processes the information and returns a result. If the result provided by the dongle matches the result expected by the local computer, the local computer will provide access to secured data, and/or permit secured software to run, on the local computer. If the result from the dongle is not what was expected by the local computer, access to the secured data and/or secured software will be denied. A dangle variation uses a wireless communications connection, with limited range, to the local computer instead of a direct physical communications connection such as that provided by a physical connection port (such as a USB port) of the local computer.

In one embodiment, the secure USB device of the invention includes a unique identification code (such as a serial number), a signature key or keys, an email encryption/decryption key or keys, and/or a vault file key or keys for encrypting and decrypting vault files on the local PC system. In one embodiment, the invention includes a master server, located at a central data location which is accessible vie the internet, which will interact with the user's computer system, and more specifically will interact with the hardened secure USB device in order to verify the authenticity of the hardened secure USB device, activate the hardened secure USB device, and/or register and/or store data specific to the particular hardened secure USB device.

In one embodiment, the invention uses a signature key or keys, which can be in the form of a unique asymmetrical key pair (e.g., signature keys), to identify the hardened secure USB device of the user. The process is completely transparent to the user, and the unique hidden asymmetrical key pairs that identify the hardened secured USB device of the user are never exposed.

In an embodiment of the invention, the secure USB device includes one or more email encryption/decryption keys, such as an asymmetrical encryption key pair comprising a public encryption key and a private decryption key

In one such embodiment, the support software automatically registers the unique device ID and key pair information of the hardened secure USB device of the user via the Internet upon installation. This guarantees that the user will be able to obtain replacements for any hardened secure USB device that is lost or stolen. This completely eliminates the need for the repeated entering of user names and passwords, while making the entire process more secure as well as transparent to the user. This system may also be used with encryption and/or decryption methods (such as standard AES, DES, TDES, and RSA encryption standards and certification certificates) as may be used by those familiar with the art. The particular security and/or encryption algorithms used with the invention can be selected from those currently available in the industry, and/or could include newly-developed algorithms, etc., depending on the particular application.

The installation process is automatic and registration is transparent to the user. When installation is occurring, the individual computer system must be on the Internet. The installation will not proceed if the individual computer system does not have Internet connectivity. The master server has one or more asymmetrical key pairs, with each key pair comprising a master server public key (for encryption) and a corresponding master server private key (for decryption of material encrypted using the master server public key). Once the individual computer system has an internet connection and is in communication with the master server, the master server transmits the master server's public key code to the individual computer system and hence to the secure USB device. The secure USB device uses the master server's public key code to encrypt the secure USB device's unique asymmetrical key pair(s) and ID information, and the secure USB device's encrypted information is then transmitted via the internet to the master server. Because the secure USB device's information was encrypted using the master server's public key, only the master server (using the master server's corresponding private key) can decrypt the secure USB device's unique asymmetrical key pair and ID information. The unique ID and key pair information of the USB device, in encrypted form using the master server's asymmetrical key pair's public key, is transmitted to the master server during installation. The unique ID and key pair information of the secure USB device is then stored, in either encrypted or non-encrypted form, on the master server database.

Because the unique key pair(s) and other ID information of the secure USB device is stored on the master server database, it is possible to manufacture a replacement secure USB device, which will be operationally identical to the original, using the secure information stored on the master server database. Accordingly, in case of loss or destruction of the originally-registered secure USB device, the user will be able to acquire a new and identical secure USB device. This eliminates the need to expose the unique ID and key pair information of the secure USB device, other than the initial exposure (during registration) of the unique ID and key pair in encrypted form. Aside from the encryption algorithm, the weakness of any encryption/decryption system is directly limited by the exposure of the very keys that are used by that system. Accordingly, the minimal exposure (and then only in highly encrypted form) of the keys and ID of the secure USB device provide exceptional security.

Each individual secure USB device is manufactured with its own unique ID and key pairs. The unique ID and key pairs are automatically generated by a computer when each secure USB device is manufactured. These unique ID and key pairs are never allowed out (except when transmitted during registration), and remain within the secure hardened device. When the secure USB device is manufactured, there is a master server database (which can be an encrypted database) that is created and stored for later retrieval and/or use by a corresponding master server. In one embodiment, this master database initially (i.e., after USB device manufacture but prior to that USB device's registration) contains only the unique ID of the devices. During registration, the master server receives the unique ID and asymmetrical key pair of the secure USB device (in encrypted form) via the internet. The master server then decrypts the unique ID, and compares the (now-decrypted) unique ID with its master server database to confirm that the secure USB device is a bona fide device. The master server then stores the asymmetrical key pairs (in encrypted form) in the master server database, where they are associated with the unique ID of the particular secure USB device.

In one embodiment, the key pairs (e.g., private and public key pairs) are only placed within the master server database in an encrypted format; however, they could also be placed therein in decrypted format. In one embodiment, the key pairs of a particular USB device are only placed in the master server database when the secure USB device is installed and registered by the user. In other embodiments, the key pairs are stored in the master server database at or around the time of manufacture, or otherwise prior to shipping and/or sale of the secure USB device. In such an embodiment, there is no need for the secure USB device to transmit its unique asymmetrical key pairs (and particularly the private key thereof) in order to register the secure USB device. Instead, the secure USB device could transmit its unique ID and/or public key (in encrypted format using, e.g., the master server public key) to the master server, but the secure USB device private key would not be transmitted. The master server could confirm the authenticity of the secure USB device using the unique ID and/or public key provided (e.g., in encrypted form) via the internet connection. Because the master server database would already have the secure USB device's private key information (having stored it during, e.g., manufacture of the USB device), the master server can authenticate the secure USB device, and have the secure USB device's unique ID and asymmetrical key pair(s) safely stored in the master server database, without the need for any transmittal of the private key(s) of the secure USB device.

In embodiments of the present invention, once the installation of a particular secure USB device has been completed for a particular PC, that secure USB device can be inserted into that same PC and the local PC's software will recognize the USB device. Once this has occurred, the user will be able to create encrypted virtual drives within the PC system, protect the user's emails and all attachments, and control the boot sequence of the PC using the secure USB device, without the user ever having to enter passwords or logons to do so.

The USB device typically utilized by people that are familiar with the art can be a secure device such as an Atmel AT90S0101, AT90S0100, or the like. It can be any similar type of secure chipset that has security protection against outside intrusions. These hardened chipsets are made to withstand hacking and are very secure. Producing them with the keys and ID and never allowing this very same information out for exposure makes them a very secure combination.

Depending on the particular embodiment, the secure USB device can be manufactured with multiple identities, multiple hidden key pairs, and also have the capability of storing a limited amount of secure data when required. This can allow for even more in-depth types of securing data. The supporting software can also allow the decryption and re-encryption of data in real time, from within the secure USB device itself, in real time and bi-directionally when this may be required.

In an embodiment of the invention, the secure USB device if lost can be securely replaced by the user when necessary, as the ID and key(s) data will have been transferred in fully encrypted format to the master server database upon installation.

If the secure USB device is lost or stolen, that secure USB device would be useless to a 3^{rd} party. The secure USB device would not work with any computer(s) other than the one(s) on which it had been properly installed during initial registration and/or subsequent installation by the original user using the user's confidential user information.

If the user's PC computer is lost or stolen, the virtual drives on the user's PC system will be inaccessible, and (depending on the particular embodiment) entirely invisible to a 3^{rd} party using that PC computer. The virtual drives are only accessible when the secure USB device is secured thereto. In a further embodiment, the PC system itself will be entirely inaccessible (i.e., will refuse to boot when powered up) in the absence of the secure USB device.

The invention thus provides enhanced security for a local PC system, as well as advanced security (via encryption/decryption) for materials such as emails and associated attachments sent via the internet or other communications methods.

Other objects, features, and advantages of the present invention will become apparent from a consideration of the following detailed description.

### BRIEF DESCRIPTION OF THE DRAWINGS

FIG. 1 is a logical diagram of a secure USB dongle and the main components according to an embodiment of the present invention;

FIG. 2 is a block diagram of the installation/registration process according to an embodiment of the present invention;

FIG. 2A is a block diagram of the installation process for an additional computer according to an embodiment of the present invention;

FIG. 3 is a block diagram of a local PC system and secure USB device; and

FIG. 4 is a block diagram of public key encryption and transmittal via email between different local PC systems.

### DETAILED DESCRIPTION

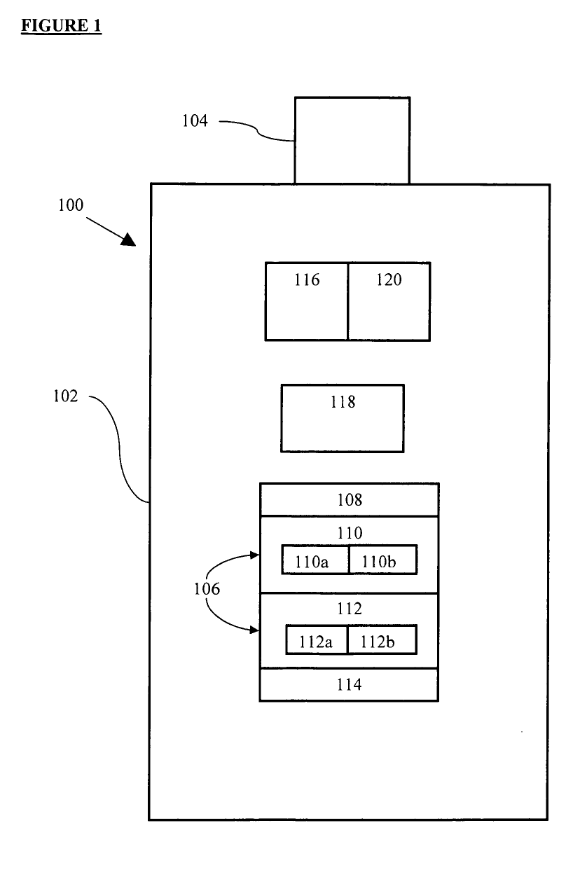

FIG. 1 depicts an embodiment of the invention, wherein a secure USB device 100 according to the invention comprises a main body 102 and a communication port, which in the particular embodiment depicted is a USB port 104. The main body 102 contains a memory 106 (which could be multiple memories) containing data in the form of a unique ID 108 (e.g., a serial number, such as a 64-bit software serial number) which is unique to the specific secure USB device 100. The memory 106 also includes an encryption key 110, a signature key 112, and a vault file encryption key 114. The memory 106 may be a permanent memory which cannot be changed once the secure USB device 100 is manufactured. In such an embodiment, the unique ID 108, encryption key 110, signature key 112, and vault file encryption key 114 are determined and entered into the device memory 106 at the time that the secure USB device 100 is manufactured.

In one particular embodiment, the encryption key 110 is an encryption key pair, and may be an asymmetrical key pair, such as a 1024-bit RSA bit key pair, comprising a public key 110a and a private key 110b. The public key 110a, e.g., encryption key, is used for public-key exchange, and can be used to encrypt email and other information. The private key 110b, e.g., decryption key, is used to decrypt email, which can include decrypting so-called “wrapped keys” inside encrypted email and/or decrypting initializing vectors inside encrypted email.

The signature key 112 is used for validation of the secure USB device 100, and may comprise an encryption key pair. In an embodiment of the invention, the signature key 112 may be an asymmetrical key pair, such as a 1024-bit RSA bit key pair, comprising a public signature key 112a and a private signature key 112b. The public signature key 112a, e.g., signature verification key, is used with one or more services (e.g., the local PC system, a remote master server, etc.) to verify that information provided has come from the particular secure USB device. The private signature key 112b, e.g., signature generation key, is used to generate a secure signature from the particular secure USB device.

The unique ID 108 (e.g., a serial number, such as a 64-bit software serial number) can be used with the private signature key 112b, e.g., signature generation key, to generate a secure signature from the particular secure USB device. For example, the private signature key 112b and unique ID 108 can be used to generate a signature using various methods, including known methods such as the “RSASSA-PKCS1-v1_{—}5” signature scheme. The unique ID 108 can also be used as an input to a signature verification process, and/or as an input to key generation (such as an LRW tweak key generation) for vault file encryption and decryption.

The vault file encryption key 114 is provided by the secure USB device 100 and is used to encrypt and decrypt vault files stored on a local PC system. The vault file encryption key 114 can be a 2-key Triple DES key, which can be in an LRW mode.

The secure USB device 100 also include a processor 116 (which could be one or more processors) configured to perform various functions, such as signature generation and/or verification, decryption of wrapped keys, decryption of wrapped initialization vectors, and/or other desired functions.

The secure USB device may also include a secure hidden storage area 118 configured to store (and provide for retrieval of) secure data such as data associated with the encryption and decryption (e.g., vault file encryption/decryption keys) of the vault files data in real time.

In an embodiment of the invention, the secure USB device 100 is preprogrammed with all necessary routines and communication protocols to be performed by the secure USB device 100. The preprogrammed routines and protocols can be included in firmware 120 (and/or software) within the secure USB device 100. The preprogramming includes all instructions for encrypted communication, encrypting and decrypting routines that operate in conjunction with the internal building blocks of the system to facilitate cryptographic acceleration, storing and retrieval of data, etc.

Note that other embodiments of a secure USB device are within the scope of the invention, including devices with a communications port other than a USB port. The communications port could be a direct connection or a wireless connection, depending on the particular embodiment.

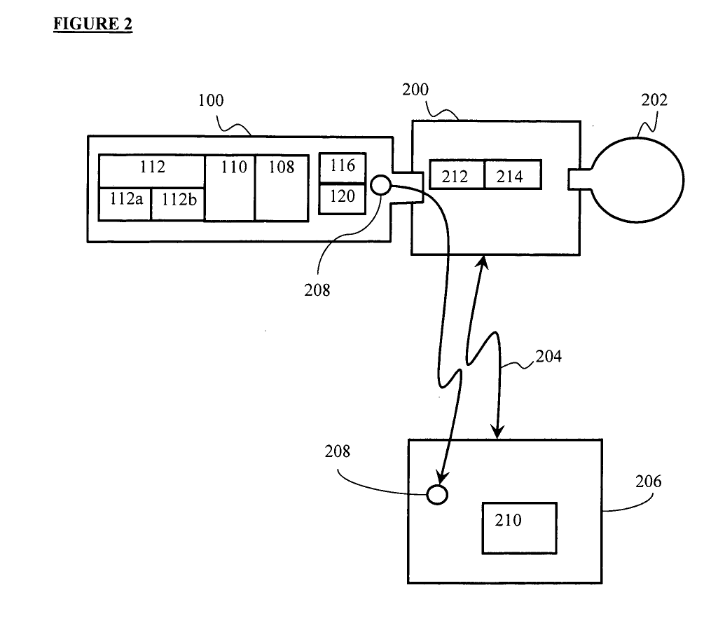

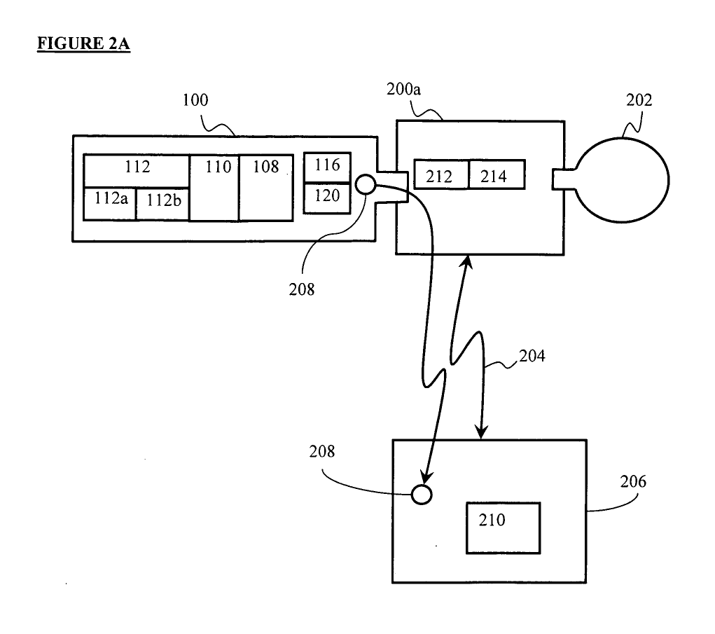

Initial installation of a secure USB device 100 to a personal computer (PC) system 200 is depicted in FIG. 2. Related installation software 202, including software for dongle interaction, is installed onto the PC system 200. Depending on the particular embodiment, initially securing the secure USB device 100 to the PC system 200 can occur prior to installation of the installation software 202, and securing the secure USB device 100 will trigger a request by the PC system 200 for a user (such as a human user) to secure a flash drive or CD or other medium containing the installation software 202 to the PC system 200. Initially securing the secure USB device 100 to the PC system 200 may additionally, or alternatively, trigger the PC system 200 to download all or a portion of the installation software 202 via an internet connection 204 from an internet site. The installation software 202 can be installed to the PC system 200 prior to securing the secure USB 100 device to the PC system 200, and the installation software 202 may request the user to secure the secure USB device 100 to the PC system 200 as part of the setup process.

In the particular embodiment depicted in FIG. 2, the secure USB device 100 and installation software 202 are secured and/or downloaded to the PC system 200 at about the same time, and the invention is shown with the installation software 202 being installed and with the secure USB device 100 secured to the PC system 200.

The installation software 202 will verify that an internet connection 204 is present and that a connection is available to the Master Server 206. If no internet connection is present, the installation software 202 will prompt the user of the absence of the internet connection 204. In one embodiment of the invention, the failure to detect an internet connection 204 to the Master Server 206 will automatically cause the installation to be stopped, which may include rolling back (i.e., undoing) all or part of any portion of the installation which was already initiated. In another embodiment, the failure to detect an internet connection 204 will generate an error message, but the user will have the option to proceed with installation.

The installation software 202 requests specific identification information 208 to be provided from the secure USB device 100. The requested specific identification information 208 may include the secure USB device's unique ID number 108 (such as a 64-bit software serial number), and may also include key information, such as encryption key information 110 and/or signature key information 112. Instead of merely providing the raw identification information that the installing software 202 has requested, the secure USB device 100 in one embodiment encrypts the identification information 208 using the secure USB device's internal processor 116 and firmware 120. The encryption can be performed using a public (encryption) key provided by the master server 206, with the master server 206 having the only access to the corresponding private (decryption) key. Accordingly, only the master server 206 will be able to decrypt the encrypted identification information 208.

The encrypted identification information 208 is encrypted within the secure USB device 100 itself, before it is ever released to the internet 204, master server 206, or even to the local PC system 200. Thus, the identification information of the secure USB device 100 is kept secure. The encrypted identification information 208 is then passed securely via the internet 204 connection to the master server 206. The encrypted identification information 208 is added to the database 210 of the master server 206 where it is stored, thus providing for registration of the particular secure USB device 100.

In an embodiment of the invention, the registration process may include sending data specific to the local PC system 200 to the master server 206. This data may include the serial number of the local PC system, etc. This data can be stored on the master server database 210, and can be used to by the master server 206 to recognize which specific local PC system is authorized for use with a particular secure USB device.

Once registration is completed, the secure USB device 100 will be operational. In one embodiment of the invention, this registration process must be completed upon installation of the installation software 202 installation or the secure USB device 100 will not be operational.

The installation software 202 also installs various software components onto the local PC system 200, including Email software 212, as well as encryption software 214, etc. The Email software 212 can be an entirely new email software package, or can be an add-on or other modification to another pre-installed software package, including currently available Email software such as Outlook®, etc. The Email software 212 is configured to enable the sending of public keys (including public encryption keys and public signature keys, which can be sent in encrypted or unencrypted form), and for encrypting and decrypting emails.

Depending on the particular embodiment, all or some of the following software components may be installed onto the local PC system during installation:
(1) Email software, such as an Outlook® add-on, for sending public keys, and/or for encrypting and decrypting emails;
(2) a public key registration program (aka Vault Key Exchange program) to add received public keys (from, e.g., users of other secure USB devices such as those of this invention) to a public key database located on the local PC system;
(3) a dongle monitoring service program to monitor the presence of the correct secure USB device on the local PC system and to take appropriate action (such as shutting down the local PC system and/or hiding the virtual vault files, etc.) if the correct secure USB device is not present;
(4) a vault file device driver that can treat a virtual vault file as a disk drive, and/or may also hide or otherwise “unmount” the virtual files if the secure USB device is not present;
(5) a vault file service program to load and interact with the vault file device driver, and/or may also hide or otherwise “unmount” the virtual files if the secure USB device is not present;
(6) a user program to interact with the vault file service program to manage the virtual vault files. The user program also interacts with the dongle monitoring service program to configure the monitor service; and
(7) a secure USB device driver for communicating to the secure USB device.

In an embodiment of the invention, the only information from the “local” secure USB device which is transmitted to the local PC system and stored thereon is a generated signature which is stored in the Windows registry. The public keys (e.g., signature keys and encryption keys) from other users of secure USB devices are stored in the public key database file of the local PC system.

In one embodiment of the invention, no secure USB device identification information is pre-provided to the master server at the time of manufacture or otherwise prior to sale of the secure USB device. In other embodiments, various secure USB device identification data may be pre-stored on the master server at the time of manufacture or at another time prior to shipping of the product for distribution to the consumer. In one embodiment, the master server 206 is provided with limited information, such as specific serial numbers or a range of serial numbers, which can permit the master server 206 to verify the authenticity of a secure USB device during the registration process. If the master server 206 determines that the identification information 208 from the secure USB device 100 is consistent with a bona fide secure USB device from, e.g., a particular manufacturer, then the master server 206 can send a signal to the local PC system 200 and/or related installation software 202 to proceed with the registration/installation process. However, if the master server 206 determines that the identification information 208 provided by the secure USB device 100 is inconsistent with a bona fide secure USB device (e.g., the identification information indicates a counterfeit or faulty device), then the master server 206 can send a signal to the local PC system 200 and related installation software 202 to stop the installation and/or registration process.

During the registration process, the master server 206 may request information from the secure USB device 100 and also from the individual user. The information requested from the secure USB device 100 can include the device serial number, the encryption keys (e.g., RSA encryption key pair, including both public and private keys), the signature keys (e.g., RSA signing key pair, including both public and private key pairs), and/or other date (such as a Triple-DES secret key). The information requested from the individual user can include name, address, phone number, and/or email address, as well as other information which may be useful in identifying the user or otherwise beneficial to the operation of the system. The master server 206 may also request or generate a user-specific password (which can be selected by the user, generated by the master server 206, etc.) for later use by the user in requesting a replacement secure USB device or for installing the same secure USB device 100 for use with a different PC system 200a, as depicted in FIG. 2A and discussed below.

If the user wants to use the secure USB device 100 with an additional computer 200a (i.e., other than the local PC system 200 from the original registration), the user will secure the secure USB device 100 to the additional computer 200a. The user may also secure a storage medium containing the installation software 202, as was done above with respect to original installation process, or the presence of the secure USB device 100 by itself may prompt a request from the additional computer 200a (via the internet 204 or other communication method) for the installation software 202 to be downloaded to the additional computer by the master server 206 or another remote source. The master server 206 will request information (e.g., identification, key pairs, etc.) from the secure USB device 100, which will then be transmitted (preferably in encrypted form) to the master server 206. The master server 206 will use to the transmitted information from the secure USB device to verify the authenticity of the secure USB device. The master server 206 will also, by comparing the transmitted information to that previously stored in the master server database 210, recognize that the secure USB device 100 has already been registered from another computer (i.e., original local PC system 200). The master server 206 will request the user to input user-specific information (e.g., name, address, email, password), which will then be transmitted (in encrypted and/or unencrypted format) to the master server 206 in order to verify that the user is the one requesting the registration with the additional computer 200a. Once the user-specific information is verified (by comparing the information to the corresponding user-specific information provided to the master server 206 during the original registration), the master server 206 will authorize the full installation of the installation software on the additional computer 200a for use with the particular secure USB device. The user will then be able to use the particular secure USB device 100 on the original local PC system 200 as well as on the additional computer 200a to secure the computer, create virtual files, send/receive encrypted emails, etc. The user can repeat the registration process for additional computers as desired.

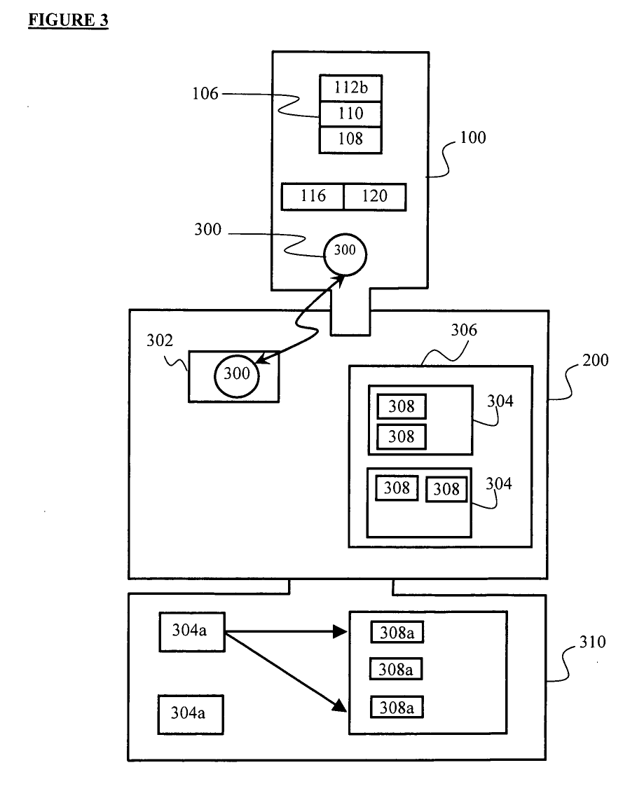

An additional step in the installation process is the generation of a secure USB device signature 300 using the private signature generation key 112b of the secure USB device 100. In one embodiment, the private signature generation key 112b is used with the secure USB device's ID 108 (e.g., serial number) to generate the secure USB device signature 300. The secure USB device signature 300 may be generated using various methods, such as a “RSASSA-PKCS1-v1_{—}5” signature scheme. The secure USB signature 300 is then stored in the registry 302 of the PC system 200, depicted in FIG. 3, for use after the secure USB device 100 is removed from the PC system. When the secure USB device 100 is re-attached to the PC system 200, the PC system 200 provides the secure USB device signature 300 back to the secure USB device 100, which verifies the secure USB device signature 300 using the verifying key 112a (i.e., the public key of the signature key pair 112). Once the secure USB device signature 300 is verified by the secure USB device 100, the secure USB device 100 will be activated (or re-activated) for use with the local PC system 200.

In one embodiment of the invention, a secure USB verification signature is generated by the secure USB device during installation, transmitted to the local PC system 200, and stored in the Windows registry of the local PC system 200. This secure USB device verification signature may be generated using various signature schemes, including known signature schemes such as the RSASSA-PKCS1-v1_{—}5 signature scheme. This involves generating a SHA-1 hash of a salt value and the serial number. The hash is then padded according to the signature scheme, before being encrypted using the signature private key. In one embodiment, the encryption of the hash is performed within the dongle/secure USB device. The encrypted padded hash (which is also the secure USB device verification signature) remains stored in the local PC system 200, even after the secure USB device 100 is removed from the local PC system 200. When the secure USB device 100 is subsequently reattached to the local PC system 200, the encrypted padded hash is transmitted back to the secure USB device 100, where it is verified within the secure USB device 100. This involves decrypting the padded hash using the signature public key. If the encrypted padded hash is not successfully decrypted, then the secure USB device is assumed not to be the original secure USB device (i.e., the secure USB device used during installation to generate the original secure USB device signature). If the padded hash is successfully decrypted, then the secure USB device generates another hash using the salt value and its serial number, which is padded according to the signature scheme. If the decrypted padded hash and the newly generated padded hash are identical, then the secure USB device is assumed to be the original secure USB device. Accordingly, the secure USB device is verified.

When the secure USB device 100 is secured to the local PC system 200 and the relevant verifications (e.g., secure USB device signature verification) have been performed, the user can create one or more virtual vault drives 304 on the hard drive(s) 306 or other memory (e.g., flash drive, etc.) of the local PC system 200. These virtual vault drives 304 can contain various confidential data files 308, such as confidential cost and accounting records, trade secrets, etc. In an embodiment of the invention, the virtual vault drives 304 and data files 308 are visible to the user, e.g., as drive/file images 304a, 308a on the PC system screen 310, where they can appear as typical drives, folders and/or files, so long as the secure USB device 100 is secured to the PC system 200. However, once the secure USB device 100 is removed from the PC system 200, the virtual vault drive images 304a and their contents/data file images 308a disappear from the PC system screen, and the virtual vault drives 304 and their contents/data files 308 are not visible or otherwise detectable to someone using the PC system 200 unless and until the secure USB device 100 is re-attached to the PC system 200. Once the secure USB device is re-attached to the PC system, the virtual vault drive images 304a and their contents/data file images 308a re-appear on the PC system screen, and the virtual vault drives 304 and their contents/data, files 308 are available for access by the user. In an alternative embodiment, when the secure USB device 300 is removed from the local PC system 200, the virtual vault drives 304 and/or their contents/data files 308a may still be visible, which can be either a regular view or a “ghosted” outline view. However, the user will not be able to open or otherwise access the actual files (e.g., word processing, etc. files), and/or view the contents/data files 308a within the virtual vault drives 304, without the presence of the secure USB device 100. The local PC system 200 may be configured, when the secure USB device 100 is absent, to prompt the user that the virtual drives 304 and/or their contents are not accessible without the secure USB device 100.

To further protect the contents of the virtual vault drives 304, their contents/data files 308 may always be saved in encrypted form using information, such as encryption/decryption keys, from the secure USB device 100. With the secure USB device 100 attached to the PC system 200, the virtual vault drives 304 and their contents/data files 308 are automatically decrypted when opened by the user. The encryption and decryption process is generally transparent to the user, whose only direct indication of the secure nature of the contents/data files 308 may be when the virtual vault drive images 304a and their contents/data file images 308a “disappear” from the PC system screen upon removal of the secure USB device 100 from the PC system 200.

In an embodiment of the invention, the virtual vault drives 304 and their contents/data files 308 are encrypted and decrypted using the vault file encryption key 114 of the secure USB device 100. The vault file encryption key 114 may be a 2-key Triple DES key, comprising Key 1 and Key 2, which can be used in an LRW mode. The encryption may be performed using a 2-key triple DES methodology operating in LRW mode. The 2-key triple DES methodology uses only two keys, Key 1 and Key 2, with Key 1 used on the first DES step, Key 2 used on the second DES step, and Key 1 used again on the third DES step. Key 1 and Key 2 are provided by the secure USB device.

In an embodiment of the invention, the vault file device driver intercepts, reads, and writes operations to the virtual vault drive 304. On reading, it will decrypt the current vault drive contents using the vault file decryption key. Depending on the particular embodiment, the decryption and/or encryption can be performed within the local PC system 200, within the secure USB device 100, and/or within a combination of the local PC system 200 and secure USB device 100. As the user writes or otherwise modifies the information within files within the virtual vault drive 304, the vault file device driver will encrypt the contents as they are saved to the local hard drive or other memory of the local PC system 200. In one embodiment, the encryption scheme for vault file encryption is Triple DES using a Triple DES key from the secure USB device 100, which may include LRW encryption mode. Note that in such an embodiment the triple DES key will have been sent to the vault file device driver when the vault drive 304 was added as a “virtual” disk drive to the hard drive or other memory on the local PC system 200). If using the LRW encryption mode, the system may use a “tweak” key, which is generated, at vault file creation, from a random number generator and stored in the encrypted header of the vault file. For security, the header may also be encrypted using the above Triple DES key in LRW mode. However, the tweak key for the header may be derived using HMAC-SHA1 or other methodologies using the secure USB device's identification information, such as the secure USB device's serial number (again sent to the driver when the vault file is to be added as a “virtual” disk drive). In one embodiment of the invention, all encryption/decryption discussed are performed inside the vault file device driver on the local PC system 200. In such embodiments, the encryption and/or decryption keys will be provided by the secure USB device 100 to the local PC system. In alternative embodiments, some or all of the encryption/decryption discussed is performed within the secure USB device, and the corresponding keys never leave the secure USB device.

The invention also includes secure encryption and decryption of emails, which can be performed using asymmetrical keys. As discussed previously, the secure USB device 100 may comprise an encryption key 110 and a signature key 112. These keys may each be key pairs, such as asymmetrical key pairs. In an embodiment of the invention, the encryption key 110 comprises a public encryption key 110a for encryption, and a private decryption key 110b for decryption. The signature key 112 comprises a public signature key 112a for signature generation, and a private signature key 112b for signature verification.

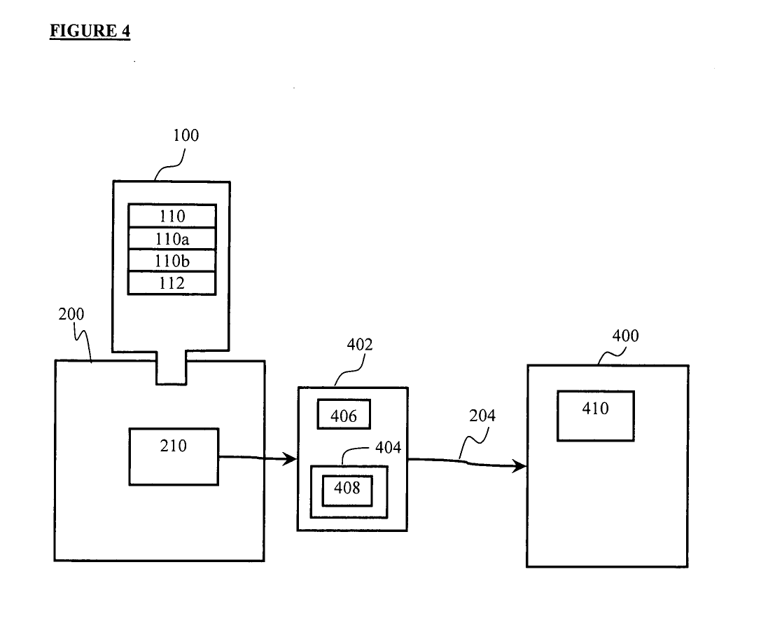

As depicted in FIG. 4, to send secure emails to another user (e.g., using another PC system 400), the local email software 210 (located on the local PC system 200) validates the secure USB device 100 as discussed previously.

The local email software 210 queries the secure USB device 100 for the encryption key 110, and (for asymmetrical key pairs) more specifically for the public encryption key 110a. The local email software 210 then packages the public encryption key 110a as an attachment file 404 in an email 402, including the user's email address 406, which is ready for the user (i.e., sender) to send to a receiver's email address. In an embodiment of the invention, the public encryption key 110a is “wrapped” or otherwise encrypted as a wrapped encryption key 408 when packaged as the attachment file 404. The user/sender then sends the email 402 via an internet connection 204 to the receiver's email address. The receiver opens the email 402 on the receiver's local PC system 400, and opens the attachment file 404 and extracts the sender's (public) encryption key 110a or keys, along with the user/sender's email address 406. The sender's (public) encryption key(s) 110a and user/sender's email address are stored in a local Vault Key Registration database file 410 located on the receiver's local PC system 400, from which the encryption key(s) 110a can be retrieved when the receiver decides to send an encrypted email to the original sender.

In one embodiment of the invention, the encryption public key 110a is not “wrapped” in the cryptography sense of the term. The encryption public key 110a is simply stored inside a file (along with some other data such as the sender's email address) which is sent to the public key recipient as an attachment. The recipient “opens” the attachment and the encryption public key 110a will be copied to the recipient's local Vault Key Registration database file 410 by the Vault Key Exchange program.

The receiver can then compose emails, encrypt them using the user/sender's (public) encryption key 110a, and send the encrypted emails to the user/sender's email address. The user/sender can then decrypt the emails using the private decryption key 110b, which remains safely within the secure USB device 100.

The above steps are necessary to permit the original receiver to send encrypted emails to the original sender, with the original sender being able to decrypt the encrypted emails using the original sender's private decryption key. In order to permit two-way exchanges (including encryption/decryption) of encrypted emails, the reverse process will have to occur, with the original receiver sending the receiver's public encryption key to the original sender, and the original sender using the receiver's public encryption key to encrypt emails for sending to the original receiver.

In an embodiment of the invention, the Public Key is itself encrypted prior to transmission in an email. In one such embodiment, each email uses a Secret Key to encrypt the data, with the Secret Key generated through the local PC system using various methods, such as a two key version of the Triple DES key. The Encryption Key 110a (i.e., public encryption key) is then used to encrypt the Secret Key, which can be encrypted using various methods such as an RSAEA-OAEP encryption scheme. The resulting encrypted Secret Key is called a Wrapped Key. When an encrypted email is received at a particular local PC system, the local (receiving) PC system email software can check for the presence of a particular attachment type, and decrypts the attachment with the following steps:
1. Attempts to find email Sender's email address and other information inside a local address book such as Outlook;
2. Looks for a match inside Sender's information in received encrypted attachment;
3. If a match is found, the local PC forwards the Wrapped (encrypted) Secret Key to the Secure USB Device 100, and the Secure USB Device 100 uses the Private Decryption Key to decrypt the Wrapped Secret Key to generate the (unwrapped, unencrypted) Secret Key;
4. Also if a match is found, the local PC forwards the Wrapped (encrypted) Initialization Vector to the Secure USB Device, and the Secure USB Device uses the Private Decryption Key to “unwrap” (decrypt) the Wrapped Initialization Vector to generate the (unwrapped/unencrypted) Initialization Vector.
5. Once the Secret Key and Initialization Vector have been unwrapped/unencrypted, the remainder of the email decryption can be performed by the local PC system using the (unwrapped/unencrypted) Secret Key and Initialization Vector.

It will be appreciated that although preferred embodiments of the present invention are described, the invention is not limited to these preferred embodiments. Persons skilled in the art will understand that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

What is claimed is:

1. A system for securing data in a local computer, the system comprising:
a secure dongle, the secure dongle comprising:
a communications port configured to communicate with a local computer;
a permanent memory, the memory comprising a permanent unique identification code, a permanent asymmetrical encryption key pair, a permanent asymmetrical signature key pair, and a permanent vault file encryption key; and
a processor, wherein the processor is configured to generate and verify signatures using the permanent asymmetrical signature key pair; and,
a software package configured for installation on the local computer, the software package configured, upon installation on the local computer, to request specific identification information from the dongle.

2. The system of claim 1, wherein the specific identification information requested from the secure dongle by the software package includes the permanent unique identification code of the secure dongle.

3. The system of claim 1, wherein the software package comprises:
a dongle monitoring service program configured to monitor the presence of the secure dongle on a local computer and to prevent access to secure information on the local computer if the correct secure dongle is not present;
a vault file device driver configured to place selected data into a virtual vault file on a local computer, and to treat the virtual vault file as a disk drive, and to prevent access to the virtual vault file if the secure dongle is not present;
a user program configured to interact with the vault file service program to manage the virtual vault files, and to interact with the dongle monitoring service program to configure the monitor service; and
a secure dongle driver for communicating to the secure dongle.

4. The system of claim 1, wherein the software package comprises:
email software configured to send public keys, and to encrypt and decrypt emails using email encryption data provided by the secure dongle using the permanent asymmetrical encryption key pair.

5. The system of claim 4, wherein the email software is configured to wrap the public keys prior to sending the public keys.

6. The system of claim 1, further comprising:
a master server, wherein the master server is connected to an internet-like connection and is configured to receive transmissions from the secure dongle via one or more local computers.

7. The system of claim 6, wherein the master server comprises a master server database, the master server database including the permanent unique identification code, permanent asymmetrical encryption key pair, permanent asymmetrical signature key pair, and permanent vault file encryption key of the secure dongle.

8. A dongle for providing access to secure data, the dongle comprising:
a communication port;
a processor configured to generate and verify signatures;
a permanent memory, the memory comprising:
a permanent unique identification code;
a permanent asymmetrical email encryption key pair comprising a public encryption key and a private decryption key;
a permanent asymmetrical signature key pair comprising a public signature key and a private signature key; and
a permanent vault file encryption key,

9. The dongle of claim 8, further comprising:
preprogrammed routines and protocols which instruct the processor to initiate encrypted communication using the permanent asymmetrical encrypted key pair, and to initiate encrypted signature generation and verification using the permanent asymmetrical signature key pair.

10. The dongle of claim 9, wherein the preprogrammed routines and protocols are included in firmware within the dongle.

11. The dongle of claim 8, wherein the vault file encryption key comprises a 2-key Triple DES key.

12. The dongle of claim 8, wherein the processor is configured to perform decryption of wrapped keys.

13. The dongle of claim 8, further comprising a secure hidden storage area configured to store, and provide for retrieval of, secure data including vault file encryption and decryption keys in real time.

14. A method for securing data on a local computer, the method performed in conjunction with the local computer and a secure device and a remote master server, wherein the secure device is configured to be secured to or placed adjacent to the local computer and to communicate with the local computer, the secure device having a unique identification number, an email encryption key comprising an email public-private key pair, and a signature generating key comprising a signature public-private key pair, the local computer having a storage medium having data thereon, the method comprising:
providing the secure device with the unique identification number, the email encryption key, and the signature generating key pre-installed in a permanent memory of the secure device;
installing a first portion of secure device support software onto the local computer, wherein the secure device support software is configured to interact with the secure device;
establishing and confirming the existence of an internet connection between the local computer and remote master server;
communicatively connecting the secure device with the local computer, wherein the secure device is secured to or placed adjacent to the local computer;
generating, within the secure device, a secure device signature using a private signature generation key from the signature public-private key pair;
transmitting the secure device signature to the local computer;
storing the secure device signature on the local computer; and
transmitting unique identifying information of the secure device to the master server via the internet connection;
confirming, at the master server, the authenticity of the unique identifying information of the secure device;
authorizing, by the master server, of installation of a remaining portion of the secure device support software onto the local computer;
transmitting, from the master server to the local computer, the authorization of the installation of the remaining portion of the secure device support software onto the local computer; and
installing the remaining portion of the secure device support software onto the local computer.

15. The method of claim 14, wherein transmitting the unique identifying information of the secure device to the master server via the internet connection comprises transmitting the unique identifying information in an encrypted format.

16. The method of claim 14, further comprising:
disconnecting the secure device from the local computer;
reconnecting the secure device to the local computer;
providing the secure device signature from the local computer back to the secure device;
verifying, within the secure device, the secure device signature using a private signature generation key from the signature public-private key pair; and
activating the secure device for use with the local computer responsive to said verification.

17. The method of claim 14, further comprising:
creating at least one virtual vault drive in a memory of the local computer;
generating a virtual vault drive image of the at least one virtual vault drive on a screen of the local computer;
preventing access to the at least one virtual vault drive when the secure device is disconnected from the local computer; and
changing the display of the virtual vault drive image of the screen of the local computer when the secure device is disconnected from the local computer.

18. The method of claim 17, wherein changing the display of the virtual vault drive image of the screen of the local computer when the secure device is disconnected from the local computer comprises eliminating the display of the virtual vault drive image.

19. The method of claim 17, wherein the dongle further comprises a vault file encryption key, and creating the at least one virtual vault drive in a memory of the local computer comprises encrypting all data to be incorporated into the at least one virtual vault drive using the vault file encryption key.

20. The method of claim 14, further comprising:
providing a public email key of the email encryption key from the secure device to the local computer;
packaging the public email key as an attachment file in a first email having a sender's email address;
forwarding the first email to an email address of a designated recipient;
opening the first email, on a local computer of the designated recipient, including extracting the public email key and determining the sender's email address;
storing the sender's email address and public email key on the recipient computer of the designated recipient;
preparing, on the recipient computer, a responsive email, including encryption of the responsive email;
sending the responsive email to the sender's email address;
opening the responsive email on the local computer; and
decrypting the responsive email using a private key of the email encryption key.
